(19) United States
(12) Patent Application Publication
(10) Pub. No.: US 2007/0254231 A1
(43) Pub. Date: Nov. 1, 2007

(54) Toner for Electrophotography

(75) Inventors: Noriaki Sakamoto, Shijyonawate-shi (JP); Yasuko Nakagawa, Neyagawa-shi (JP)

Correspondence Address: GROSSMAN, TUCKER, PERREAULT & PFLEGER, PLLC, 55 SOUTH COMMERICAL STREET, MANCHESTER, NH, 03101, US

(73) Assignee: KYOCERA MITA CORPORATION, Osaka (JP)

(21) Appl. No.: 11/740,021

(22) Filed: Apr. 25, 2007

(30) Foreign Application Priority Data
Apr. 27, 2006 (JP) 2006-123416
Sep. 4, 2006 (JP) 2006-239389

(51) Int. Cl. G03G 9/08

(52) U.S. Cl. 430/109.3; 430/111.4; 430/123.52

(57) ABSTRACT

A toner for electrophotography, wherein the toner is prepared by a suspension polymerization or emulsion polymerization from a monomer composition comprising a monovinyl monomer and a coloring agent, and a filtration velocity of the toner is in the range of 0.1 to 3.0 mL/min. The filtration velocity is obtained by an evaluation method comprising following evaluation steps:
(i) 15 mg of a toner is added to 5 mL of THF, and soluble component in the toner is dissolved in THF completely to prepare a sample liquid; and
(ii) the sample liquid is filtrated at the temperature of 25° C. and pressure of 0.15 kgf/cm² is applied using a filter wherein an area thereof is 4.0 cm² and a pore size thereof is 0.45 μm to measure a filtration time wherein 1 mL of the sample liquid is passed through the filter, and a filtration velocity is determined using the filtration time by a following formula,

Filtration velocity (mL/min)=1 (mL)/filtration time (min).

### BACKGROUND OF THE INVENTION

1. Field of the Invention

The present invention relates to a toner for electrophotography.

2. Description of Related Art

A contact-heating method using a heat roll or the like has been mostly adopted as a method for fixing a toner to a recording medium with an electrophotographic image forming apparatus. Very accurate controls of linear velocity and temperature are required in the contact-heating method in order to achieve sufficient fixing property especially when plural toner layers arc laminated on a recording medium at a full-color printing or a toner is fixed on various recording media. On the other band, it is important to control thermal properties of a toner, and thermal properties of a toner such as fixing property, offset-resistance and the like arc required to be compatible with an image forming apparatus to which the toner is used in order to improve reliability and to simplify systems of image forming. (Here, “offset” means a phenomenon in which a toner within an image is non-preferably transferred and adhered to the side of a heat-roller after fixing, although the toner is required to be fixed and remained on paper or the like.) Therefore, adjustments of a releasant, molecular weight of a matrix resin, viscosity and the like are conducted to control thermal characteristics of a toner.

When a pulverized toner obtained by pulverizing a melt-kneaded material which includes a binder resin, a releasant, a coloring agent, a charge controlling agent and the like (for example, refer to Japanese Unexamined Patent Application, First Publication Nos. 2005-266788 and Hei 05-6031) is used, it is possible to control fixing properties of a toner easily to some extent by adjusting properties of the binder resin, kneading conditions and the like. Accordingly, a control range of the fixing property (fixing margin) of such a toner is broad, and thermal characteristics of the toner can easily be compatible with an image forming machine used.

On the other hand, a polymerized toner which can be produced by a suspension polymerization or emulsion polymerization does not include a kneading step in a production method thereof. Accordingly, the number of conditions and steps which can be used for controlling the fixing property of a toner of a polymerized toner is not large as compared with those for a pulverized toner, and therefore, the fixing property of a polymerized toner is influenced directly by the property of a binder resin used for a polymerized toner. In this way, the fixing margin of a polymerized toner is narrow generally, and it is difficult to make the thermal-property of a toner (fixing property and offset resistance) compatible with an image forming apparatus.

For example, a polymerized toner wherein the amount of a component insoluble in tetrahydrofuran (THF) is adjusted to 10 to 60% by mass to improve an offset resistance is proposed in Japanese Unexamined Patent Application, First Publication No. 2004-294997. Indeed, an offset resistance is improved by increasing the amount of a component which is insoluble in THF. However, even if the content of a component insoluble in tetrahydrofuran is merely increased, that is, the content of a component having high molecular weight is merely increased, melting viscosity becomes high, and therefore fixing property, especially fixing property at the low temperature, deteriorates Accordingly, there are problems in that the allowable range of the amount of a component which is insoluble in THF, wherein both of offset resistance and fixing property can be achieved, is very narrow, that is, a fixing margin is very small.

On the other hand, a toner which includes a binder resin including a gel component (a toluene-insoluble component) is proposed as a toner which can improve hot-offset resistance (refer to a Japanese Patent Document No. 2512442). Indeed, a hot-off-set resistance of a toner is improved by including a large amount of a gel component. However, when the amount of a gel component is merely increased, the fixing property of a toner deteriorates at a low temperature. Further, it is difficult to disperse a gel component in a toner particle non-uniformly, and therefore, a mass of the gel component tends to disperse in a toner particle non-uniformly. Furthermore, such a gel component has a large cross-link density, and therefore pigment hardly disperses in the gel component itself. Accordingly, pigment tends to disperse only in a non-gel component (toluene-soluble component) in a binder resin of a toner, and as a result, pigment dispersibility in a toner deteriorates and problems regarding deterioration of coloring property of an image occur. Such problems regarding deterioration of coloring property of an image occur to a significant degree, when a full-color printing is conducted wherein plural toner layers are fixed.

The object of the present invention is to overcome problems of the conventional techniques as described above.

That is, the object of the present invention is to provide a toner for electrophotography, wherein the fixing property thereof does not deteriorate even when plural toner layers are fixed, and offset resistance (especially, hot-offset resistance) is excellent, and an adjustable range of a firing property (fixing margin) is large.

Furthermore, the object of the present invention is to provide a toner for electrophotography, which is excellent in hot-offset resistance, fixing property at a low temperature and an image coloring property.

### BRIEF DESCRIPTION OF THE DRAWINGS

FIG. 1 represents a chart which shows variations of the temperature regarding the melting viscosity of toners of Examples and Comparative Examples of the first aspect of the present invention.

FIG. 2 represents a GPC chart of one example of a toner (T_{A}) obtained by a suspension polymerization using a monomer composition (M_{A}), which includes a monovinyl monomer, a cross-linkable monomer, pigment and the like, of the second aspect of the present invention.

FIG. 3 represents a GPC chart of one example of a standard toner (T_{B}) obtained by a suspension polymerization using a monomer composition (M_{B}), which is prepared similar to the toner (T_{A}) except that said cross-linkable monomer is not used, of the second aspect of the present invention.

### SUMMARY OF THE INVENTION

A toner for electrophotography of the first aspect of the present invention is a toner which is prepared by a suspension polymerization or emulsion polymerization from a monomer composition including a monovinyl monomer and a coloring agent, and a filtration velocity of the toner is in the range of 0.1 to 3.0 mL/min, and the filtration velocity is obtained by an evaluation method including the following evaluation steps.

### Evaluation of Filtration Velocity

(i) 15 mg of a toner is added to 5 mL of THF, and a soluble component in the toner is dissolved in THF completely to prepare a sample liquid.

(ii) The sample liquid is filtrated at the temperature of 25° C. and a pressure of 0.15 kgf/cm² is applied using a filter wherein an area thereof is 4.0 cm² and a pore size thereof is 0.45 μm to measure a filtration time wherein 1 mL of the sample liquid is passed through the filter, and a filtration velocity is determined using the filtration time by a following formula.

Filtration velocity (mL/min)=1 (mL)/filtration time (min).

A toner for electrophotography of the second aspect of the present invention is a toner for electrophotography, wherein the toner includes a binder resin and a pigment; and

when filtration of a liquid wherein 50 mg of a toner is added to 15 mL of THF is conducted with a mesh having 650 μm openings, none of a THF-insoluble component remains on the mesh; and

when filtration of said liquid is conducted with a mesh having 150 μm openings, a THF-insoluble component of the binder resin remains on the mesh; and

a THF-insoluble component of the binder resin includes a pigment therein.

### DETAILED DESCRIPTION OF THE INVENTION

While preferred embodiments of the invention will be described and illustrated below, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

Toners of the first aspect and second aspect of the present invention are toners including a binder resin and a coloring material (hereinafter, said toner may be described simply as a “toner”. A toner described for the second aspect of the present invention may be described as a toner (T_{A})), which can be prepared by a suspension polymerization or emulsion polymerization using a monomer composition which includes a monovinyl monomer and pigment. The monomer composition and production method thereof of the present invention can include and/or use various additives such as a cross-linkable compound, a charge controlling agent, a releasant, a polymerization initiator, a molecular weight controlling agent, a lubricant and/or a dispersion stabilizer as required.

### A Toner, Functions and Effects of the Toner of the First Aspect of the Present Invention

A toner for electrophotography of the first aspect of the present invention is a toner which can be obtained by a suspension polymerization or emulsion polymerization using a monomer composition including a monovinyl monomer and a coloring agent, and the filtration velocity of the toner evaluated by the aforementioned filtration velocity evaluation method is in the range of 0.1 to 3.0 mL/min. Therefore, even if plural layers of different toners are fixed, fixing property does not deteriorate and offset resistance is excellent (especially, hot offset resistance), and furthermore the adjustable range of the fixing property (fixing margin) is large. The reasons for such excellent properties of the toner are described below.

In order to improving the adhesiveness of a melted toner to a recording medium, it is necessary to decrease the melting viscosity with respect to the temperature. However, when the melting viscosity of a toner is merely lowered, offset resistance of the toner deteriorates unpreferably. Accordingly, when the melting viscosity of a toner is intended to be lowered, it is necessary to improve offset resistance by, for example, adding a polymer component, which has a self cohesion property, to provide the polymer component within the toner. For example, a polymerized toner including a THF-insoluble component is proposed in the aforementioned Japanese Unexamined Patent Application, First Publication No. 2004-294997. However, by merely increasing the amount of a THF-insoluble component, that is, by merely increasing the amount of components having high molecular weight, the melting viscosity of a toner increases, that is, the toner is hardly fixed at a low temperature, and fixing property deteriorates.

As described above, a fixing margin can exist in a comparatively large range when a pulverized toner obtained by pulverizing a kneaded material, which is obtained after melt-kneading of toner materials is used as those in the conventional methods. The reason thereof is that it is comparatively easy to adjust a fixing property of such a toner by adjusting the properties of a binder resin used, conditions of kneading and the like. On the other hand, a polymerized toner has the problem in that the fixing property of the polymerized toner is greatly affected by the property of a used binder resin itself, and therefore, the fixing margin tends to be narrow.

In order to solve the problems, the present invention aims at both the size (molecular weight) of a THF-insoluble component (hereinafter, it may be described as a THF-insoluble component) and the content of the THF-insoluble component, instead of aiming at merely the content of a THF-insoluble component as disclosed in the conventional techniques. That is, in the present invention, it is possible to evaluate the amounts of THF-insoluble component having a predetermined size, which can not be filtrated by a filter having a pore size of 0.45 μm, by using a liquid wherein a toner is dissolved in THF and filtrating it by a filter having a pore size of 0.45 μm in order to confirm the degree of ease of the passage of the component.

This method is very simple but very useful to determine and select a toner which satisfies a suitable balance between the size of a THF-insoluble component and the content of the THF-insoluble component When the filtration velocity is larger than 0.3 mL/min and smaller than 0.1 mL/min, suitable results cannot be obtained, and therefore it is possible to determine from the values that a suitable balance of the size of the THF-insoluble content and the amount of the THF insoluble content is not achieved in a toner.

When the filtration velocity is smaller than 0.1 mL/min, it can be assumed that the size of a THF-insoluble content is too large in total and/or the content of a THF-insoluble component is too large, or the like. For example, the following case can be cited as an example in which there is too large an amount of a THF-insoluble component wherein the size (molecular weight) thereof cannot be filtrated by a mesh of 0.45 μm openings. Here, when a mesh is blocked by a THF-insoluble component and evaluation cannot be completed, it is determined that the filtration velocity is less than 0.1 mL/min.

When the filtration velocity is larger than 0.3 mL/min, it can be assumed that the size of THF-insoluble content is too small in total and/or the content of a THF-insoluble component is too small, or the like. For example, such a case can be cited as an example in which there is too small an amount of a THF-insoluble component having a size (molecular weight) which cannot be filtrated by a mesh having 0.45 μm openings. Here, the content of a THF-insoluble component having a size (molecular weight) which cannot be filtrated by a mesh of 0.45 μm openings is not limited. It is preferable that the content of a THF-insoluble component within a toner be 5% by mass or more and 40% by mass or less, and more preferably 10% by mass or more and 30% by mass or less.

In this way, by selecting a toner in which a predetermined amount of a THF-insoluble component having a suitable size (molecular weight) is introduced, it is possible to provide a toner which is excellent in offset resistance (particularly, hot-offset resistance) without deterioration of the fixing property of the toner. Here, a THF-insoluble component means a group which may include plural polymers. A THF-insoluble component having a suitable size (molecular weight) of the present invention includes a group of polymers which show suitable molecular weight distribution and have a suitable crosslinked structure. In the present invention, by conducting the evaluation in accordance with the first aspect of the present invention, it is possible to distinguish a suitable toner which includes a preferable group of polymers insoluble in THF from an unpreferable toner which includes an unpreferable group of polymers insoluble in THF.

Furthermore, a THF-insoluble component having a suitable size (molecular weight) can show an excellent effect of improving offset resistance, even if the amount of the component is small. Furthermore, even when a comparatively large amount of such a THF-insoluble component having a suitable size is included in a toner, the lowering degree of fixing property is small, and therefore, a large controllable range of fixing property of the toner can be maintained. Accordingly, it is possible to provide a toner which has a wide fixing margin by the present invention.

Furthermore, in the first aspect of the present invention, by adjusting the amount of the cross-linkable compound, it is possible to control the amount and the size of THF-insoluble components easily. Particularly, by using a macro monomer as the cross-linkable compound, it is possible to introduce the suitable amount of a THF-insoluble component(s) having a suitable size (molecular weight) to a toner, without measuring the molecular weight of a binder resin excessively in total Furthermore, by using a macro monomer as the cross-linkable compound, it is possible to obtain a toner which has excellent fixing property, since offset resistance of the toner can be achieved while melt viscosity of the toner is low.

As described above, by the first aspect, a toner for electrophotography can be provided toner has a wide controllable range (fixing margin), and is excellent in an offset resistance (particularly, hot offset resistance), and does not cause deterioration of the fixing property, even when plural toner layers are fixed.

### A Toner, and Functions and Effects Thereof of the Second Aspect of the Present Invention

A toner for electophotography of the second aspect of the present invention is a toner which includes a binder resin and a pigment; and (a) when a liquid wherein 50 mg of a toner is added to 15 mL of THF and filtration of the liquid is conducted with a mesh having 650 μm openings, none of a THF-insoluble component exists on tile mesh after the filtration, and (b) when filtration of said liquid is conducted with a mesh having 150 μm openings, a THF-insoluble component of the binder resin exists on the mesh after the filtration; and (c) a THF-insoluble component of the binder resin includes a pigment therein.

It is preferable that said toner for electrophotography of the second aspect of the present invention be a toner (hereinafter, it may be described as a toner (T_{A})) which is obtained by polymerizing a monomer composition (herein after, it may be described as a monomer composition (M_{A})), which includes a monovinyl monomer, a cross-linkable compound including a macro monomer and a pigment, by a suspension polymerization or emulsion polymerization method.

The monomer composition (M_{A}) can include various kinds of additives such as a charge controlling agent, a releasant, a polymerization initiator, a molecular weight controlling agent, a surface lubricant and a dispersion stabilizer if required.

In the toner for electrophotography of the second aspect of the present invention, the binder resin thereof includes a THF-insoluble component, that is, a gel component. Therefore, hot offset resistance of the toner is excellent. In the present invention, the gel component can mean a three-dimensional crosslinked polymer. When a THF-insoluble component is included in a conventional toner, dispersibility of pigment in the toner deteriorates and coloring property of an obtained image deteriorates. However, in the toner of the present invention, as those described in the aforementioned proviso (c), such a toner which includes a THF-soluble component and a THF-insoluble component, wherein pigment exists therein, can be selected in advance. Accordingly, dispersibility of pigment within a selected toner is excellent and therefore coloring property of an obtained image is excellent. It is possible to prepare a toner including a THF-soluble component and a THF-insoluble component, wherein pigment dispersibility is excellent, for example, by controlling conditions of crosslinking.

Furthermore, by satisfying the aforementioned provisos (a) and (b) regarding the meshes, it is possible to achieve both of fixing property at a low temperature and hot offset resistance. The reasons for these achievements are described below.

In order to improve fixing property of a melted toner to a recording medium, it is necessary to decrease melt viscosity of a toner, that is, it is necessary to prepare a toner which can fix to a recording medium at a low temperature. However, if melt viscosity of a toner is lowered, hot-offset resistance of the toner is also lowered. Therefore, it is necessary to improve a hot-offset resistance by, for example, adding a high polymer component which can realize self-cohesion in the interior of a toner. For example, Japanese Patent No. 2512442 discloses a toner which includes a gel component. However, when the content of a gel component is merely increased, the lower limit of the range of fixable temperature is increased, and therefore, fixing property at a low temperature deteriorates and cold-offset tends to be caused easily. In this way, fixing property at a low temperature and hot-offset resistance have a trade-off relationship with each other, that is, there is a tendency that one is improved while the other deteriorates. Accordingly, both of hot offset resistance and fixing property at a low temperature cannot be improved only by determining the amount of the gel component.

In order to solve the above problems, not only the content of a gel component but also the size of a gel component was studied in the present invention. That is, a gel component having suitable size can exist in a toner when the following conditions are satisfied. When a liquid wherein 50 mg of a toner is added to 15 mL of THF and filtration of the liquid is conducted with a mesh having 650 μm openings, none of a THF-insoluble component exists on the mesh after the filtration, and when filtration of said liquid is conducted with a mesh having 150 μm openings, a THF-insoluble component of the binder resin exists on the mesh after the filtration. Due to this method, it is possible to confirm and select a toner wherein too large THF-insoluble component is not included in the toner, and preferable THF-insoluble component having predetermined size or more are included in the toner. The gel component having a suitable size as those determined by the present invention can melt easily even at a low temperature. Accordingly, a toner having such a gel component can show low melt viscosity at a low temperature, and therefore the toner can achieve sufficient fixing property at a low temperature. Furthermore, even if a toner has such low melt viscosity, the toner can achieve sufficient hot-offset resistance by selecting and including preferably a gel component. The amount of a THF-insoluble component that exists on a mesh having 150 μm openings after the filtration is preferably 10 to 40% by mass, and more preferably 20 to 30% by mass, based on the total amounts (100%) of a toner.

Here, the reasons a mesh having 650 μm openings and a mesh having 150 μm openings are selected and used are that, after many experiments were conducted repeatedly, it was confirmed that it is possible to obtain a toner excellent in both of offset resistance and fixing property at a low temperature in good efficiency due to the use of these meshes. That is, it is possible to achieve effective selection of a toner having suitable size and amount of a THF-insoluble component by using the meshes. Fixing property deteriorates when the size of the gel component is too large, but offset resistance at the high temperature deteriorates when the size of the gel component is too small. It is necessary for a suitable size of a gel component in good balance to exist in a toner.

The content of the gel component can be measured by the following method. A liquid wherein a toner (T_{A}) is dissolved in THF is filtrated with a mesh having a pore size of 0.45 μm at pressure of 0.15 kgf/cm². Then, evaluation of gel permeation chromatography (GPC) of the filtrate was conducted to obtain a GPC chart of a material from which a gel component, which cannot pass through the mesh, of the toner (T_{A}) is removed. On the other hand, a binder resin which is included in a standard toner (T_{B}), which is obtained by a polymerization using a monomer composition (M_{B}) without a cross-linkable monomer, does not have a cross-link structure provided by the cross-linkable monomer, and therefore, the binder resin can dissolve in a THF at a rate of about 100%. Accordingly, due to the comparison between the area (S_{B}) of the standard toner (T_{B}) of the GPC chart and the area (S_{A}) of the toner (T_{A}) of another GPC chart, the amount of the gel component which cannot pass through the filter having a pore size of 0.45 μm can be evaluated based on the difference of the areas.

In this way, due to the introduction of the optimum amount of a THF-insoluble component having the optimum size into the toner (T_{A}), it is possible to provide a toner wherein it is excellent in offset resistance (particularly, hot offset resistance) and achieves a wide range of fixable temperature, and fixing property does not deteriorate even if plural layers of such toners are fixed.

That is, it is possible in the second aspect of the present invention to provide a toner for electrophotography excellent in hot offset resistance, fixing property at a low temperature and coloring property.

Hereinafter, materials, manufacturing methods and evaluating methods which can be used for the first aspect and second aspect of the present invention are explained below.

### Monovinyl Monomer

A monovinyl monomer which can be used for the monomer composition of the first and the second aspects of the present invention is a monomer which has one polymerizable unsaturated carbon-carbon double bond. Examples of a group which has the polymerizable unsaturated carbon-carbon double bond include a vinyl group, an acryloyl group and a methacryloyl group.

Examples of the monovinyl monomer include: aromatic vinyl monomers such as styrene, vinyltoluene and a-methyl styrene; (meth)acrylic acid; derivatives of (meth)acrylic acid such as methyl(meth)acrylate, ethyl(meth)acrylate, propyl(meth)acrylate, butyl(meth)acrylate, 2-ethylhexyl (meth)acrylate, cyclohexyl isobornyl(meth)acrylate, dimethylaminoethyl(meth)acrylate and (meth)acrylic acid amide; and mono-olefin monomers such as ethylene, propylene and butylene. Said (meth)acrylic acid may mean acrylic acid and/or methacrylic acid.

The monovinyl monomer can be used singly or in combination of two or more. Among the monovinyl monomers, it is preferable that an aromatic vinyl monomer be only used, or the aromatic vinyl monomer be used in combination with a derivative of (meth)acrylic acid.

### Coloring Agent

Coloring agent which can be used in the first and the second aspects of the present invention includes conventional pigments and dyes usable for a toner. The toner of the present invention may be a toner for mono-color print or a toner for full color print In the present invention, when there is not described in particular, a coloring agent can mean a pigment and/or a dye.

Examples of a black coloring agent include: pigments and dyes which are originating from carbon black or nigrosin: and magnetic particles such as cobalt, nickel, iron oxide black, manganese iron oxide, zinc iron oxide and nickel iron oxide. When the carbon black is used, it is preferable that carbon black having an average primary particle diameter of 20 to 40 nm be used from the viewpoints of achieving an excellent image quality and high safety of a toner to the environment.

Examples of a coloring agent for color toner include: a yellow coloring agent, a magenta coloring agent and a cyan coloring agent.

Examples of the yellow coloring agent include condensation azo compounds, isoindolinone compounds, anthraquinone compounds, azo metal complexes, methine compounds and allyl amide compounds. Concrete examples thereof include: C.I. Pigment Yellows 3, 12, 13, 14, 15, 17, 62, 65, 73, 74, 83, 90, 93, 95, 96, 97, 109, 110, 111, 120, 128, 129, 138, 147, 155, 168, 180 and 181; and Naphthol Yellow S, Hansa Yellow G, and C.I. Vat Yellow.

Examples of the magenta coloring agent include: condensation azo compounds, diketo pyrrolo pyrrole compounds, anthraquinone compounds, quinacridone compounds, basic dye chelate compounds, naphthol compounds, benzimidazolone compounds, thioindigo compounds and perylene compounds. Concrete examples thereof include C.I. Pigment Red 2, 3, 5, 6, 7, 23, 48, 48:2, 48:3, 48:4, 57, 57:1, 58, 60, 63, 64, 68, 81, 81:1, 83, 87, 88, 89, 90, 112, 114, 122, 123, 144, 146, 149, 163, 166, 169, 170, 177, 184, 185, 187, 202, 206, 207, 209, 220, 251 and 254; and C.I. Pigment Violet 19.

Examples of the cyan coloring agent include: copper phthalocyanine compounds and derivatives thereof, anthraquinone compounds and basic dye chelate compounds. Concrete examples thereof include: C.I. Pigment Blue 1, 2, 3, 6, 7, 15, 15:1, 15:2, 15:3, 15:4, 16, 17, 60, 62 and 66; Phthalocyanine Blue, C.I. Vat Blue and Acid Blue.

These coloring agents may be used singly or in combination of two or more. The coloring agent is preferably used in the range of 0.1 to 50 parts by mass, more preferably 0.5 to 30 parts by mass and still more preferably 1 to 20 parts by mass, based on 100 parts by mass of the monovinyl monomer.

### Cross-Linkable Compound

A cross-linkable compound can be preferably used in the first and the second aspects of the present invention. The cross-linkable compound is a compound which has two or more polymerizable unsaturated carbon-carbon double bonds. Examples of a group having the polymerizable unsaturated carbon-carbon double bond include a vinyl group, an acryloyl group and a methacryloyl group. Due to the use of the cross-linkable compound, hot-offset resistance can be improved Examples of the cross-linkable compound include a crosslinkable monomer and a cross-linkable polymer.

The cross-linkable compound may be used singly or in combination of two or more.

Examples of the cross-linkable monomer include: aromatic divinyl monomers such as divinylbenzene, divinyl naphthalene and derivatives thereof; esters of (meth)acrylic acid and polyhydric alcohol such as ethylene glycol dimethacrylate, diethylene glycol dimethacrylate and 1,4butanediol diacrylate; divinyl monomers such as N,N-divinyl aniline and divinyl ether; and polyfunctional monomers such as pentaerythritol triallyl ether and trimethylolpropane triacrylate.

Examples of the cross-linkable polymer include esters obtained from unsaturated carboxylic acid such as (meth)acrylic acid and polymer such as polypropylene, polyester, polyethylene glycol and polyethylene which have two or more hydroxyl groups.

In the first and second aspects of the present invention, it is preferable that a macro monomer described below is included as a cross-linkable polymer. Concretely, it is preferable that the cross-linkable compound is a macro monomer or at least one of the cross-linkable compounds used is a macro monomer. Furthermore, the cross-linkable polymer itself may be a macro monomer.

In the first aspect of the present invention, the amount of the cross-linkable compound can be selected as required. The cross-linkable compound can be preferably used in the range of 0.5 to 5 parts by mass, more preferably 0.5 to 4.5 parts by mass, and still more preferably 1.0 to 3.0 parts by mass, based on 100 parts by mass of the monovinyl monomer.

In the second aspect of the present invention, too large an amount of the cross-linkable compound is unpreferable, since cross-link density of a THF-insoluble component is increased excessively and pigment cannot disperse in such a THF-insoluble component. The amount of a cross-linkable compound other than macro monomer can be selected as required. The amount of such a cross-linkable compound other than macro monomer is preferably 30 parts by mass or less, and 0 parts by mass is the most preferable. That is, the amount of a macro monomer as a cross-linkable compound is 70 part by mass or more based on the total of cross-linkable compounds. The amount of the macro monomer is preferably 0.5 to 5 parts by mass based on 100 parts by mass of a monovinyl monomer.

### Macro Monomer

In the first aspect and second aspects of the present invention, a macro monomer can be used preferably.

In the first aspect of the present invention, it is possible to maintain a good balance between fixing property at low temperature and resistance to aggregation of a toner at high temperature when a macro monomer is used as a cross-linkable compound or one part of the monovinyl monomer.

In the second aspect of the present invention, it is possible to achieve excellent dispersibility of pigment in a THF-insoluble component included in a binder resin.

A macro monomer is a macromolecule which has one or more, preferably two or more, polymerizable unsaturated carbon-carbon double bonds at the terminal end(s) of the molecular chain thereof. In general, the macro monomer is an oligomer or polymer having a number average molecular weight in the range of 500 to 30000. A polymer having a number average molecular weight of about 1000 to 30000 may be also referred to as a macro monomer frequently. When the number average molecular weight is within the above range, fixing property and resistance to aggregation of toner can be maintained without deteriorating melting property of a macro monomer.

Examples of the polymerizable unsaturated carbon-carbon double bond existing at the terminal end of the molecular chain include a vinyl group, an acryloyl group and a methacryloyl group. From the viewpoint of conducting copolymerization with ease, a methacryloyl group is preferable.

It is preferable that such a macro monomer be selected such that when said macro monomer is used in combination with the aforementioned monovinyl monomer to produce a polymer, the obtained polymer can have the glass transition temperature higher than the glass transition temperature of a polymer which is obtained only from a monovinyl monomer without a macro monomer.

Examples of the macro monomer include: polymers which can be obtained by polymerizing one of or two or more of styrene, styrene derivatives, methacrylate, acrylate, acrylonitrile, methacrylonitrile and the like; and macro monomer having a polysiloxane skeleton. Among them, a hydrophilic macro monomer is preferable, and a polymer which can be obtained by polymerizing methacrylate and/or acrylate singly or in combination is particularly preferable.

In the first aspect of the present invention, it is preferable that a macro monomer having the number average molecular weight of 500 to 5000 and having two or more polymerizable unsaturated carbon-carbon double bonds be used as a cross-linkable compound. In this case, a high cross-linked component can be introduced in a toner, even when the average molecular weight of a polymer included in a toner is not so large. It is preferable that the number average molecular weight of a macro monomer be in the range of 500 to 4000, and more preferably 1000 to 3000.

Furthermore, in the first aspect of the present invention, the amount of the macro monomer is preferably in the range of 0.5 to 4.5 parts by mass, more preferably 0.5 to 3.5 parts by mass, and still more preferably 1.0 to 3.0 parts by mass based on 100 parts by mass of the monovinyl monomer. When the amount of the macro monomer is within the range, fixing property can be improved while resistance to aggregation of a toner is maintained.

In the second aspect of the present invention, it is preferable that a macro monomer, which has two or more polymerizable unsaturated carbon-carbon double bonds at the terminal end of molecular thereof and has the number average molecular weight of in the range of 500 to 5000, be used as a cross-linkable compound. It is more preferable that the number average molecular weight thereof be 500 to 4000, and still more preferably 1000 to 3000. this case, crosslinked structure can be formed easily, even when the average molecular weight of a polymer included in a toner is not so large. Furthermore, due to the use of a macro monomer having such a number average molecular weight, suitable cross-linked structure having moderate voids in the component can be formed wherein pigment can enter in a THF-insoluble component easily but hardly pass through a THF-insoluble component.

In the second aspect of the present invention, the amount of a macro monomer included in a monomer composition (M_{A}) is preferably in the range of 0.5 to 5 parts by mass, more preferably 0.5 to 0.45 parts by mass, and still more preferably 0.5 to 3.5 parts by mass, and most preferably 0.5 to 2.5 parts by mass, based on 100 parts by mass of a monovinyl monomer. When the macro monomer is used in an amount of 0.5 parts by mass or more, a THF-insoluble component can be sufficiently introduced in a toner to achieve excellent hot-offset resistance of the toner. When the macro monomer is used in an amount of 5 parts by mass or less, excellent dispersibility of pigment into a THF-insoluble component of a binder resin can be achieved.

In the second aspect of the present invention, due to the use of macro monomer as a cross-linkable monomer, excellent dispersibility of pigment into a THF-insoluble component in a binder resin can be achieved. If the aforementioned other cross-linkable compound is used solely instead of macro monomer, cross-link density of the THF-insoluble component may be excessively increased, and therefore pigment cannot disperse in the THF-insoluble component sufficiently.

### Charge Controlling Agent

In the first aspect and second aspect of the present invention, various kinds of a positive or negative charge control agent can be added to a monomer composition used for a toner. Examples of the charge control agent include metal complex of an organic compound having a carboxyl group or a nitrogen including group, metal comprising dye, nigrosine and a charge controlling resin.

Concrete examples of the charge control agent include: charge control agents such as Bontoron N-01 (available from Orient Chemical Industry Co., Ltd.), Nigrosine Base EX (available from Orient Chemical Industry Co., Ltd.), Spiron Black TRH (available from Hodogaya Chemical Co., Ltd.), T-77 (available from Hodogaya Chemical Co., Ltd.), Bontoron S-34 (available from Orient Chemical Industry Co., Ltd.), Bontoron E-81 (available from Orient Chemical Industry Co., Ltd.), Bontoron E-84 (available from Orient Chemical Industry Co., Ltd.), Bontoron E-89 (available from Orient Chemical Industry Co., Ltd.), Bontoron F-21 (available from Orient Chemical Industry Co., Ltd.), Copy Charge NX VP434 (available from Clariant Co., Ltd.), Copy Charge Nneg “VP2036 (available from Clariant Co., Ltd.), TSN-4-1 (available from Hodogaya Chemical Co., Ltd.), TNS-2 (available from Hodogaya Chemical Co., Ltd.), LR-147 (available from Japan Carlit Co., Ltd.) and Copy Blue PR (available from Clariant Co., Ltd.); and charge control resins such as a copolymer having a quaternary ammonium (salt) group and a copolymer having a sulfonic acid (salt) group. The charge control agent can be used singly or in combination of two or more.

The amount of the charge control agent is preferably used in the range of 0.01 to 10 parts by mass, more preferably 0.1 to 10 parts by mass and still more preferably 0.3 to 5 part by mass, based on 100 parts by mass of the monovinyl monomer.

Here, the toner of the present invention may be a negative toner or a positive toner. The charge of a toner may be controlled by selecting a suitable charge controlling agent.

### Releasant

In the first aspect and second aspect of the present invention, in order to improve offset resistance and/or releasing ability at the time of heat-roll fixing, releasant can be added in a monomer composition (a monomer composition (M_{A}), when it is proposed for the second aspect). Examples of the releasant include: polyolefin waxes such as low-molecular-weight polyethylene, low-molecular-weight polypropylene and low-molecular-weight polybutylene; vegetable natural waxes such as candelilla wax, carnauba wax, rice wax, Japan wax and Jojoba wax; petroleum waxes and modified waxes thereof such as paraffin, micro crystalline wax, petrolatum; synthetic waxes such as Fischer-Tropsh wax; and polyfunctional ester compounds such as pentaerythritol tetamyristate, pentaerythritol tetrapalmitate and dipentaerythritol hexamyristate.

These releasants can be used singly or combination of two or more. Among these releasants, synthetic wax, terminal-end modified polyolefin waxes, petroleum waxes and/or polyfunctional ester compounds are preferable. The amount of the releasant is preferably in the range of 0.1 to 50 mass parts, more preferably 0.5 to 20 parts by mass and still more preferably 1 to 10 parts by mass, based on 100 parts by mass of monovinyl monomer.

### Polymerization Initiator

In the first aspect and second aspect of the present invention, a polymerization initiator can be used suitably. Examples thereof include: persulfates such as potassium persulfate and ammonium persulfate; azo compounds such as 4,4′-azobis-(4-cyanovaleric acid), 2,2′-azobis-[2-methyl-N-(2-hydroxyethyl))propionamide], 2,2′-azobis-(2-amidinopropane)bihydrochloride, 2,2′-azobis-(2,4-dimethyl valeronitrile) and 2,2′-azobis-(2-methylpropionate); peroxides such as di-t-butyl peroxide, dicumyl peroxide, lauroyl peroxide, benzoyl peroxide, t-butylperoxy-2-ethylhexanoate, t-hexylperoxy-2-ethylhexanoate, t-butyl peroxypivalate, di-isopropyl peroxydicarbonate, di-t-butyl peroxyisophthalate, 1,1′,3,3′-tetmethylbutylperoxy-2-ethylhexanoate and t-butyl peroxyisobutyrate; and redox initiators composed of combinations of these polymerization initiators with a reducing agent.

Among these initiators, oil-soluble initiator which can be soluble in a monovinyl monomer is preferable, and a water-soluble initiator can be used in combination as required.

The amount of the polymerization initiator is preferably in the range of 0.1 to 20 parts by mass, more preferably 0.3 to 15 parts by mass and still more preferably 0.5 to 10 parts by mass, based on 100 parts by mass of the monovinyl monomer. The polymerization initiator may be added in a monomer composition (a polymer composition (M_{A}), when it is proposed in the second aspect of the invention) in advance. On the other hand, the polymerization initiator may be added to a suspension or emulsification liquid of a monomer composition in the middle of or before a polymerization in order to suppress an early polymerization.

### Molecular Weight Adjusting Agent

In the first aspect and second aspect of the present invention, a molecular weight adjusting agent can be used preferably. A molecular weight adjusting agent can be used for a polymerization for a monomer composition (monomer composition (M_{A}), when it is proposed in the second aspect of the present invention).

Examples of the molecular weight adjusting agent include: mercaptans such as t-dodecyl-mercaptan, n-dodecyl-mercaptan, n-octyl-mercaptan, 2,2,4,6,6-pentamethylheptane-4-thiol; and halogenized hydrocarbons such as carbon tetrachloride and carbon tetrabromide.

The amount of the molecular weight adjusting agent is preferably in the range of 0.01 to 10 part by mass, more preferably 0.05 to 8 parts by mass and still more preferably 0.1 to 5 parts by mass, based on the 100 parts by mass of a monovinyl composition The molecular weight adjusting agent may be added in a monomer composition in advance. On the other hand, the polymerization initiator may be added to a suspension or emulsification liquid of a monomer composition in the middle of or before a polymerization.

### Dispersion Stabilizer

In the first aspect and second aspect of the present invention, a dispersion stabilizer can be used preferably. Preferable dispersion stabilizer can selected and used as required, and a colloid of a metal compound which is hardly soluble in water is preferable. Examples of the metal compound which is hardly soluble in water include: sulfate such as barium sulfate and calcium sulfate: carbonates such as barium carbonate, calcium carbonate and magnesium carbonate; phosphates such as calcium phosphate; metal oxides such as aluminium oxide and titanium oxide; and metal hydroxides such as ferric hydroxide, aluminium hydroxide and magnesium hydroxide. Among the metal compounds which are hardly soluble in water, a colloid of a metal compound which is hardly soluble in water is preferable from the point that it is possible to narrow the particle distribution of polymer particles and clearness of an image can be improved.

As the colloid of a metal compound which is hardly soluble in water, a colloid of metal hydroxide which is hardly soluble in water is preferable. Such colloid can be obtained by controlling pH of an aqueous solution of an aqueous polyvalent metal compound to 7 or more. Colloid of metal hydroxide which is hardly soluble in water is still more preferable when it is a colloid which is generated by a reaction conducted in the aqueous phase of a water-soluble polyvalent metal compound and a hydrogenated alkali metal salt.

The colloid of the metal compound which is hardly soluble in water has preferably the particle diameter (D50) of 0.5 μm or less and the particle diameter (D90) of 1 μm or less. The particle diameter (D50) means the particle size at 50% of the number particle size distribution, and the particle diameter (D90) means the particle size at 90% of the number particle size distribution. The above percent and size are determined by counting the number of the particle cumulatively from the smaller particle side to the larger particle side in the particle size distribution.

A water-soluble polymer can be used as the distribution stabilizer as needed. Examples of the water soluble polymer include polyvinyl alcohol, methyl cellulose and gelatin.

In the present invention, although it is not necessary to use a surfactant, a surfactant can be used as the distribution stabilizer in order to carry out a suspension polymerization, insofar as the environmental dependability of electrostatic charge characteristics of a toner is not increased.

The amount of the distribution stabilizer can be selected if needed. The amount is preferably in the range of 0.1 to 20 parts by mass and more preferably 0.1 to 10 parts by mass, based on 100 parts by mass of a monovinyl monomer. When the amount of the distribution stabilizer is too small, it is difficult to achieve sufficient polymerization stability and aggregate of polymers tends to be generated. When the amount of the distribution stabilizer is too large, the viscosity of an aqueous solution used for forming a toner increases and polymerization stability deteriorates.

### Production Method of a Toner

A toner of the first and second aspects of the present invention (toner (T_{A}), when it is proposed in the second aspect) can be obtained by polymerizing a monomer composition (monomer composition (M_{A}), when it is proposed in the second aspect of the present invention) by a suspension-polymerization method or an emulsion-polymerization method. The toner is a colored polymer particle wherein a polymer obtained by a polymerization of a monovinyl monomer and a cross-linkable compound (macro monomer may be included therein), where the cross-linked compound is used additionally if required, is included in the toner as a binder resin. A colorant and another additive such as a charge control agent and a releasant, which can be added if required, are dispersed in the binder resin.

A toner of the present invention can be produced in accordance with preferable conditions if required. Concrete examples of the production method of a toner include, as those described below, a production method which includes the steps of: producing fine droplets of a monomer composition in an aqueous dispersion medium used for forming a toner (a droplet forming step), polymerizing the monomer composition having the form of droplets (polymerization step), and washing and drying colored polymer particles obtained (collecting step).

### Droplet Forming Step

A monovinyl monomer, a cross-linkable compound (a cross-linkable compound including a macro monomer, when it is proposed in the second aspect of the present invention), coloring agent and other additives, which can be added if required, are mixed with a mixer, and furthermore a wet-pulverization thereof is conducted using a media type wet-pulverizing device (for example, a bead mill) if required, to prepare a monomer composition.

Then, the obtained monomer composition is added to an aqueous dispersion medium, and the mixture is stirred to disperse the monomer composition such that uniform droplets of the monomer composition are formed preliminary (primary droplets which have a volume average particle diameter of about 50 to 1000 μm). The stirred mixture is further stirred to obtain a suspension (or emulsion) with a high-speed rotary-shear type stirring device or the like, to such a degree that a particle diameter of the droplets becomes a size which is almost the same as the aimed particle diameter of a toner.

When pigment for color toner is used as coloring agent and a charge controlling resin is used as a charge controlling agent, it is possible to prepare a pigment masterbatch by kneading a pigment and a charge controlling resin in advance, and then the pigment masterbatch may be mixed with a monomer composition.

As the aqueous dispersion medium, water such as ion exchanged water can be used generally. Hydrophilic solvent such as alcohol can be added to the dispersion if required.

When a polymerization initiator is used, the initiator is preferably added to the dispersion immediately before the stirring which is conducted with a high-speed rotary-shear type stirring device, in order to avoid early polymerization.

When a dispersion stabilizer is used, the stabilizer is preferably added to an aqueous dispersion medium before a monomer composition is added.

The volume mean particle diameter and the particle size distribution of the droplets of the monomer composition included in the suspension influence the volume mean particle diameter and the particle size distribution of a toner obtained. When the particle diameter of droplets is too large, the diameter of toner particles will become too large and the resolution of au obtained image will deteriorate. When the particle size distribution of droplets is broad, the particle size distribution of a toner will become broad, and therefore, variation of fixable temperature will arise, and defects such as generating of fogging and toner filming will arise. Therefore, it is preferable that droplets of a monomer composition be formed so that the size of droplets is the almost the same as the size of a toner required.

As the volume mean particle diameter of droplets of a monomer composition, particle diameter Dv50 (μm) is used in which the diameter is determined as a diameter at 50% of the number particle distribution by counting the volume cumulatively from the smaller particle side. The particle diameter Dv50 (μm) of droplets (hereinafter, it may be described as droplet particle diameter Dv) can be evaluated, for example, by using a SALD particle size analyzer (available from Shimadzu corporation).

The size shown by the particle diameter Dv50 (μm) of droplets of a monomer composition can be determined as required, and the size is preferably in the range of 3 to 10 μm, more preferably 4 to 9 μm and still more preferably 4 to 8 μm. It is effective to use a toner having the small particle size in order to form a fine image, and therefore, it is preferable that droplet particle diameter Dv be small.

A particle diameter distribution of droplets of a monomer composition (volume mean particle diameter/number mean particle diameter) is preferably in the range of 1 to 2, more preferably 1 to 1.8 and still more preferably 1 to 1.5.

The method for controlling the droplet particle diameter Dv of a monomer composition can be selected as required, and examples thereof include a method wherein the amount of a dispersion stabilizer such as a colloid of a metal compound which is hardly soluble in water is controlled. However, the droplet particle diameter Dv is also affected by stirring condition for a dispersion liquid or the like. Accordingly, in order to achieve the droplet particle diameter Dv which is almost the same as a desired particle size, it is preferable to adjust the amount of the dispersion stabilizer at first, and furthermore control the stirring conditions and the like.

A stirrer can be selected as required. Examples thereof include: (1) a dispersing device represented by a multi-stage in-line dispersion machine available from IKA company of Germany and EBARA MILDER which is available from Ebara Corporation, that is, a dispersion device which stirs a dispersion in a space formed between a rotor and a stator thereof by flowing the dispersion from an inside of the rotor to an outside of the stator while the rotor and the stator which are formed in a comb-like shape and arranged in a concentric relation with each other are rotated at a high speed; (2) a stirring device represented by CLEAR MIX CLM-0.8S (available from M. Technique Co., Ltd.), which forms droplets by the actions such as shear force generated by a rotor rotating at a high speed and a screen surrounding the rotor, collision force, pressure variation, cavitation and potential core; and (3) a stirring device represented by TK type homomixer (available from Tokusba Kika Kogyou Co., Ltd.), which forms droplets by forcing the dispersion against a side wall of a homogenization vessel by means of a centrifugal force thereby forming a liquid film thereon and then contacting the resultant film with a tip of a stirring body which is rotating at an extremely high speed.

### Polymerization Step

Hereinafter, a polymerization step is explained based on a suspension-polymerization method mainly.

Suspension polymerization is performed by providing a suspension containing droplets of a monomer composition into a polymerization vessel, and heating the suspension. Polymerization temperature can be selected if needed. The polymerization temperature is preferably in the range of 5 to 120° C., more preferably 20 to 110° C. and still more preferably 35 to 95° C. When polymerization temperature is too low, it is necessary to use a polymerization initiator having high activity, and therefore, it is difficult to control a polymerization reaction. When polymerization temperature is too high and an additive which melts at a low temperature is used, this additive bleeds on the toner surface and resistance to aggregation of toner deteriorates occasionally.

As a monovinyl monomer contained in a monomer composition, a monovinyl monomer, which can produce a polymer having the glass transition temperature Tg) of 80° C. or less, preferably in the range of 40 to 80° C. and still more preferably 50 to 70° C., or combination of the monovinyl monomer, can be selected and used from the viewpoint of decreasing the fixing temperature of a toner. Tg of a polymer is a calculated value based on the kinds and ratio of a monovinyl monomer used.

Colored polymer particles wherein a coloring agent and the like are dispersed in a polymer can be obtained by the above suspension polymerization. The above colored polymer particles may be used as is, via a collecting step. It is also possible to form a polymer layer on the obtained colored polymer particles to prepare core-shell type polymer particles. Such particles can be used as a toner to improve properties of a toner such as resistance to aggregation of toner (blocking resistance), fixing properly at a low temperature and melting property at the time of fixing. Due to the use of core-shell type polymer particles, it is possible to prepare a toner which can achieve high speed printing (copy, printing and the like), formation of a full-color image, excellent permeability which can be used for an OHP (overhead projector) and the like.

Examples of a manufacturing method of core-shell type polymer particles include a method wherein the aforementioned obtained colored polymer particles are used as a core particle, and a monomer for a shell is further polymerized under existence of the core particle to form a polymer layer (shell) on the surface of the core particles.

As the monomer for shell, any one can be selected as required, and examples thereof include those cited as examples of the aforementioned monovinyl monomer. From the viewpoint of improving resistance to aggregation of a toner, it is preferable to select a monomer for shell which can form a polymer having higher Tg than a polymer used for forming a core particle. Due to the use of such a monomer, it is possible to set Tg of a polymer used for forming a core particle at low temperature, and therefore, it is also possible to decrease the fixing temperature of a toner and/or improve melting characteristics of a toner.

Tg of a monomer for the core and a monomer for the shell can be selected if needed.

It is preferable that a monomer for core be a monomer which can form a polymer wherein Tg thereof is preferably 60° C. or less, and more preferably 40 to 60° C., from the viewpoint of achieving good balance between fixing temperature and a resistance to aggregation of a toner. It is also preferable that a monomer such as styrene and methyl methacrylate, which can form a polymer having Tg more than 80° C., be used as a monomer for the shell.

Tg of a polymer formed from a monomer for the shell is preferably more than 50° C. and 120° C. or less, more preferably more than 60° C. and 110° C. or less, and still more preferably more than 80 and 105° C. or less. The difference between Tg of a polymer formed from a monomer for the core and a polymer formed from a monomer for the shell can be determined if needed. The difference is preferably 10° C. or more, more preferably 20° C. or more and still more preferably 30° C. or more.

The mass ratio of a monomer for the core and a monomer for the shell (monomer for core/monomer for shell) can be determined if needed. It is preferable that mass ratio be 40/60 to 99.9/0.1, more preferably 60/40 to 99.7/0.3, and still more preferably 80/20 to 99.5/0.5. When the ratio of a monomer for shell is too small, the effect of improving the resistance to aggregation of a toner is small. When the ratio of a monomer for shell is too large, the effect of reducing the firing temperature is small.

A charge controlling agent can be added to a monomer for the shell. Examples of the charge controlling agent can include those described above. The amount of the charge controlling agent is preferably in the range of 0.01 to 10 parts by mass, more preferably 0.03 to 8 parts by mass and still more preferably 0.1 to 5 parts by mass, based on 100 parts by mass of a monomer for the shell.

When a monomer for the shell is added, it is preferable that a water-soluble polymerization initiator be also added to conduct a polymerization effectively. Examples of the water-soluble polymerization initiator include: persulfates such as potassium persulfate and ammonium persulfate, and azo compounds such as 2,2′-azobis[2-methyl-N-(2-hydroxyethyl)propionamide] and 2′2-azobis[2-methyl-N-(1,1-bishydroxumethyl)ethyl)propionamide].

The amount of a water-soluble polymerization initiator is preferably in the range of 0.1 to 50 parts by mass and more preferably 1 to 20 parts by mass, based on 100 parts by mass of a monomer for shell.

The average thickness of a shell can be determined if need. The thickness is preferably in the range of 0.001 to 1.0 μm, more preferably 0.003 to 0.5 μm and still more preferably 0.005 to 0.2 μm. When the thickness of a shell is too thick, fixing property of a toner deteriorates. When the thickness of the shell is too thin, resistance to aggregation of a toner deteriorates. When it is possible to observe a core and a shell formed on the core with an electron microscope, the size of the core and the thickness of the shell may be determined by selecting some particles from photographs at random and measuring the selected particles directly to determine the size of the core and the thickness of shell. When it is difficult to observe a core and a shell with an electron microscope, they are determined by the calculation using the particle diameter of a core particle and the amount of a used monomer for the shell.

### Collecting Step

The aforementioned polymerization step provides a dispersion liquid containing colored polymer particles (they may be core-shell type polymer particles). In the collecting step, a filtrating and washing step, a drying step and the liker can be performed in that order. In a filtrating and washing step, it is possible to use the dispersion liquid obtained at the polymerization step as it is, and it is also possible to add ion exchanged water or the like to the dispersion liquid in order to adjust concentration of colored polymer particles.

In a filtrating and washing step, in order to dissolve and remove a dispersion stabilizer, it is possible to carry out an acid washing, an alkali cleaning or the like, in accordance with the kind of used dispersion stabilizer. For example, when a colloid of metal hydroxide which is hardly dissolved in water such as magnesium hydroxide is used as a dispersion stabilizer, said colloid can be dissolved in an aqueous dispersion medium by adding an acid such as dilute sulfuric acid to acidify pH of the dispersion liquid and dissolve the colloid in an aqueous medium.

Furthermore, it is possible to carry out a demonomer processing such as stripping processing while the state of the dispersion liquid is maintained. Furthermore, it is possible to aggregate or associate colored polymer particles to control the particle diameter of colored polymer particles.

Examples of a filtrating and washing method include a method wherein filtration and washing of colored polymer particles are carried out simultaneously by using a vacuum type belt filter.

After a washing step, colored polymer particles (wet cake) are collected in a wet state. The collected colored polymer particles can be dried according to a conventional method. In this way, dried colored polymer particles, that is, a toner (toner (T_{A}), when it is proposed in the second aspect) can be obtained.

### Volume Mean Particle Diameter

The volume mean particle diameter (Dv) of a toner of the first aspect and the second aspect of the present invention is preferably in the range of 3 to 10 μm, more preferably 4 to 9 μm, and still more preferably 4 to 8 μm. In order to obtain a high fine image by improving the resolution of an image, small volume mean particle diameter of a toner is preferable.

Volume mean particle diameter (Dv) can be measured as follows.

Coulter multi-sizer II or III (available from Coulter Ltd.) is used as a measuring device, and it is connected to an interface and a personal computer which output a number average distribution and a volume average distribution. For electrolyte solution, sodium chloride (extra pure) is used to prepare 1% NaCl aqueous solution. 0.1 to 5 ml of a dispersion agent as a surface active agent (preferably, it is alkylbenzene sulfonate) is applied to 100 to 150 ml of the electrolyte solution, and 0.5 to 50 mg of a toner as a measurement sample is further applied thereto to form a suspension. The electrolyte solution including the toner is subjected to a dispersion processing in an ultrasonic dispersion device for about one to three minutes. Then, by using the measuring device and the dispersion, the volume distribution and the number distribution of the toner are determined using a 100 μm aperture to obtain a volume mean particle diameter.

### Melting Viscosity

In the first aspect of the present invention, it is preferable that the melting viscosity of a toner at 120° C. be in the range of 1×10⁵ to 1×10⁶ dPas. When the melting viscosity of a toner at 120° C. is included in the range, excellent fixing property can be achieved over the wide range of a fixing temperature. The melting viscosity of a toner can be determined while heating the toner from 40° C. at a temperature-rising rate of 6° C./min with a flow tester under the following conditions: preheating time: 300 seconds, load: 20 kgf, a diameter of die: 1 mm, length of die: 1 mm and plunger area: 1 cm².

### Number Average Molecular Weight

The number average molecular weight (polystyrene standard) of a binder resin is preferably in the range of 7000 to 30000, and more preferably 8000 to 30000, which can be obtained by conducting GPC (gel permeation chromatography) measurement of a sample liquid (sample liquid A, when it is proposed in the second aspect) which is passed through a filter having a pore size of 0.45 μm. The sample liquid can be prepared at the time of an evaluation of filtration velocity of the first aspect of the present invention and a GPC measurement of the second aspect of the present invention. For example, it is preferable that the number average molecular weight be 25000 or less, such as 7000 or more and 25000 or less. When the aforementioned number average molecular weight is less than 8000, melt viscosity may be decreased and offset caused at high temperature (hot-offset) may be caused. When the number average molecular weight exceeds 30000, melt viscosity may increase and fixing property at low temperature deteriorates.

Plural peaks derived from plural components included in a toner are observed in a GPC chart obtained by GPC measurement. Among these peaks, a peak derived from a binder resin included in a toner is selected, and the number average molecular weight of the binder resin is determined based on the peak derived from the binder resin. The origin of a peak can be determined by a method wherein each component is measured solely to conduct a reference. Commercial GPC equipment can be used for the GPC measurement. A commercial column or the like can be also used for the measurement. THF can be used as a solvent for the measurement.

### Measurement of the Filtration Velocity of the First Aspect

A toner of the first aspect of the present invention has characteristics such that the size (molecular weight) and the amount of a THF-insoluble component have been adjusted moderately. That is, in the first aspect of the present invention, the filtration velocity which can be obtained by the following procedures of (I-i) to (I-ii) is in the range of 0.1 to 0.3 ml/min, and more preferably 0.15 to 0.25 mL/min. When the filtration velocity is less than 0.1 mL/min, the amount of a THF-insoluble component having the too large a molecular weight is large to deteriorate the fixing property of a toner. When the filtration velocity exceeds 0.3 mL/min, the amount of a THF-insoluble component having the suitable size is insufficient to deteriorate offset resistance. The reason a filter (area: 4.0 cm², pore size: 0.45 μm) is used, is that it was found as the result of repeating experiments that such a size of a mesh can be used most preferably to determine the filtration velocity. When openings of a mesh are too small, it is impossible to conduct measurement since the openings are blocked. When openings of a mesh are too large, all of a THF-insoluble component passes through, and it is impossible to estimate both of the amount and the size of a THF-insoluble component based on the time.

By adjusting the amount and the size (molecular weight) of a THF-insoluble component suitably, it is possible to obtain a toner which is excellent in offset resistance (especially hot-offset resistance) without deteriorating fixing property, and achieves wide control range (fixing margin) regarding fixing property.

(I-i) 15 mg of a toner is added to 5 mL of THF, and a soluble component of the toner is dissolved completely to prepare a sample liquid.

(I-ii) Using a filter having aim area of 4.0 cm² and a pore size of 0.45 μm, filtration is conducted until 1 mL of the sample liquid has passed through the filter at the temperature of 25° C. and at the pressure of 0.15 kgf/cm², to obtain the time required for completing the filtration. The filtration velocity of the liquid is obtained by the following formula.

Filtration velocity (mL/min)=1 (mL)/filtration time (min).

Hereinafter, the aforementioned (I-i) and (I-ii) are explained in detail.

### Procedure of (I-i)

The amount of both of a toner and THF are measured accurately. The dissolution of a soluble component of a toner into THF is performed sufficiently using a ball mill or a stirrer over one to five hours. The dissolution may be carried out while heating it in the range of room temperature and 50° C. The aforementioned amount of THF is determined such that a THF-soluble component included in a toner can be dissolved completely.

### Procedure of (I-ii)

Filtration is conducted in the procedure. A commercial filter for a pretreatment of a sample of HPLC (high performance liquid chromatograph) can be used as a filter of the filtration conducted in the procedure. A syringe filter which includes generally a film and housing thereof and furthermore also has joint portions at the top of and the bottom of as an inlet and an outlet, or the like can be used as said filter. Examples thereof include CHROMATDISK 25N (available from Juji Field inc.). The nominal pore size value of a commercial filter used can be used as a pore size of the present invention.

The pressure force at the time of filtration can be adjusted by, for example, selecting a suitable weight, which can be attached to press a piston portion of a syringe used for the filtration. From the beginning of the filtration to when 30 seconds has passed, the filtration is carried out by only the pressure provided by the weight of a sample liquid itself. When 30 seconds have passed, the pressure of 0.15 kgf/cm² is applied to the sample liquid. Then, filtration time from the pressure of 0.15 kgf/cm² is applied and until 1 mL of the sample liquid has passed the filter is measured.

### Confirmation of the THF-Insoluble Component Remaining on a Mesh after the Filtration of the Second Aspect

A toner for electrophotography of the second aspect of the present invention is a toner which includes a binder resin and a pigment, and which is satisfied with the following conditions (a) to (c).

(a) When a liquid wherein 50 mg of a toner is added to 15 mL of THF is filtered with a mesh having an opening diameter of 650 μm, a THF-insoluble component of a binder resin included in a toner does not remain on a mesh.

(b) When a liquid wherein 50 mg of a toner is added to 15 mL of THF is filtered with a mesh having an opening diameter of 150 μm, a THF-insoluble component of a binder resin included in a toner remains on a mesh.

(c) A pigment exists within a THF-insoluble component of a binder resin.

Each condition is described below.

### Conditions (a) and (b)

The dissolution of a soluble component of a toner into THF is carried out sufficiently at 25° C. over one hour with a ball mill or a stirrer. As a mesh used for the conditions, commercial meshes for sieves can be used. The nominal value of a commercial mesh can be used as a mesh opening of the present invention.

Whether or not a THF-insoluble component exists on the mesh can be determined by visual observation or variations of weight of the mesh before and after the filtration. The THF-insoluble component may be confirmed with a microscope or a magnifying glass. When variations of weight of a mesh are confirmed, it is possible to measure the weight of the mesh after the filtration, by drying the mesh after the filtration under the reduced pressure to volatilize THF.

### Condition (c)

Whether or not pigment is included in a THF-insoluble component can be determined such that the THF-insoluble component remaining on a mesh having an opening diameter of 650 μm is confirmed by visual observation. The THF-insoluble component on the mesh may be confused with a microscope or a magnifying glass.

### GPC Measurement of the Second Aspect

It is preferable that the amount of a THF-insoluble component of a toner be adjusted moderately. A toner for electrophotography of the second aspect of the present invention is a toner (T_{A}) which can be obtained from a monomer composition (M_{A}) including a monovinyl monomer, a cross-linkable compound including a macro monomer and a pigment by a suspension polymerization or emulsion polymerization method. It is preferable that the ratio of the peak area (S_{A}) derived from a binder resin shown in the GPC chart of a toner (T_{A}) based on the peak area (S_{B}) (100%) derived from a binder resin shown in a GPC chart of a standard toner (T_{B}), which are obtained by the following GPC measurement, be 50 to 95%. Tlat is, in the second aspect of the present invention, the ratio of the peak area (S_{A}), which is originated from a binder resin of an object from which a THF-insoluble component, which cannot pass through a filter having 0.45 μm openings, has been removed from a toner as those conducted by following procedures (II-i) to (I-ii), is 50 to 90%, based on the peak area (SB) (100%) originated from a binder of a standard toner (T_{B}) obtained by following procedures (II-i) to (II-v). The ratio is more preferably in the range of 60 to 90%, and still more preferably 70 to 90%. The standard toner (T_{B}) is a toner which is produced similar to a toner (T_{A}) of the second aspect of the present invention except that a cross-linkable compound is not used.

It is assumed that a toner (T_{A}) of the second aspect of the present invention includes about 5 to 50% of a THF-insoluble component which cannot pass through a filter having an opening diameter of 0.45 μm.

The methods of the (I-i) and (I-ii) are the same as those of the above (I-i) and (I-ii).

(II-i) A toner (T_{A}) is prepared, and then 15 mg of the toner is added to 5 mL of THF-soluble components of the toner are dissolved in THF completely to prepare a sample liquid A.

(II-ii) Using a filter having an area of 4.0 cm² and a pore size of 0.45 μm, filtration of the sample liquid A is conducted at the pressure of 0.15 kgf/cm² to remove a THF-insoluble component which cannot pass through the filter.

(II-iii) Measurement of gel permeation chromatography (GPC) of a sample A passed through the filter is conducted to obtain a GPC chart, and the peak area (S_{A}) between a peak line originated from a binder resin and a base line is determined. A peak derived from a binder resin can be determined by a data obtained by a measurement of a binder resin solely.

(II-iv) A standard toner is obtained by polymerizing a monomer composition (M_{B}), which has the same composition as the monomer composition (M_{A}) except that a cross-linkable compound is not used, under the same conditions of those of the monomer composition (M_{A}).

(II-v) Using the standard toner (T_{B}), aforementioned (II-i) to (II-iii) are conducted to obtain a peak area (S_{B}) originated from a binder resin of the toner from a GPC chart of the standard toner (T_{B}).

Hereinafter, each of (II-i) to (II-iv) is further explained in detail.

### Procedure of (I-i)

The amounts of a toner and THF are measured accurately. The dissolution of a soluble component included in a toner into THF is performed sufficiently using a ball mill or a stirrer over one to five hours. The dissolution may be carrier out while heating it in the range of room temperature and 50° C.

### Procedure of (II-ii)

Filtration is conducted. A commercial filter for a pretreatment of a sample of HPLC as described above can be used. The nominal value of a used commercial filter can be used as a pore size of the present invention. The pressure force at the time of the filtration can be adjusted, for example, by selecting a suitable weight which can be attached to press a piston portion of a syringe used for the filtration.

### Procedure of (II-iii)

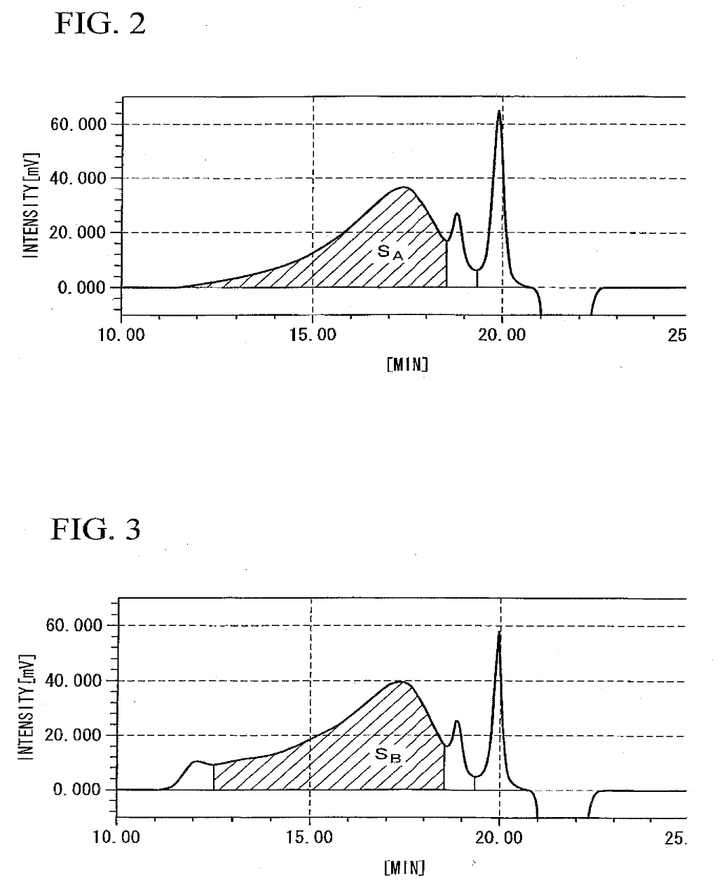

Commercial GPC equipment can be used as GPC equipment which can be used for the GPC measurement of the present invention. A commercial column or the like can be also used as a column used in the measurement. THF can be used as a solvent for the measurement. Flow rate is 1.0 mL/min. By conducting GPC measurement, for example, a GPC chart as shown in FIG. 2 can be obtained. A horizontal axis means elution time (min) and a vertical axis means intensity (mV).

The GPC chart shown by FIG. 2 is a GPC chart of a toner (T_{A}) which is obtained by a polymerization of a monomer composition (M_{A}) containing a monovinyl monomer (100 parts by mass), a cross-linkable compound (3 parts by mass), a pigment and the like by a suspension-polymerization method.

A peak area (S_{A}), which exists between a base line and a peak line derived from a binder resin, is obtained from the GPC chart. Here, in the case of the GPC chart of FIG. 2, a peak derived from a binder resin is a peak wherein the elution time is about from 12.5 to 18.5 minutes, and peak area (S_{A}) is 8000 (mV·S).

### Procedure of (II-iv)

A standard toner (T_{B}) is a toner which is obtained by polymerization of a monomer composition (M_{B}) under the same conditions as those of monomer composition (M_{A}) except that a cross-linkable compound is not used. If the composition of the monomer composition (M_{A}), from which a cross-linkable compound is deleted, is not the same as the composition of the monomer composition (M_{B}) for any reason such that a different kind of monovinyl monomer is used, a different ratio of the monovinyl compositions is used when two or more monovinyl monomers are used, or a different pigment or the like is used, comparison of the GPC chart of a toner (T_{A}) and the GPC chart of a toner (T_{B}) is difficult since concentration of a binder resin included in the sample liquid B changes and the absorption coefficient of the binder resin and the like are also changed.

### Procedure of (II-v)

The area (S_{B}) of the GPC chart of a standard toner (T_{B}) is determined by conducting operations similar to the aforementioned (II-i) to (II-iii). In order to perform comparison with the GPC chart of a toner (T_{B}) and the GPC chart of a toner (T_{A}), it is necessary to measure the amounts of a toner (T_{B}) and THF accurately so that concentration of a standard toner (T_{B}) of sample liquid B and concentration of the toner (T_{A}) of sample liquid A are the same. It is necessary to perform filtration such that a filter and conditions used are the same as those of the aforementioned (II-ii). It is also necessary to conduct GPC measurement such that GPC equipment and conditions thereof are the same as those of the aforementioned (II-ii).

The GPC chart shown as FIG. 3 is a GPC chart of the standard toner (T_{B}) which is obtained by polymerizing the monomer composition (M_{B}) which has the same composition as that of the monomer composition (M_{A}) except a cross-linkable compound is not used, under the conditions which are the same as those for the monomer composition (M_{A}). The peak area (S_{A}) between a peak line originated from a binder resin and a base line shown in the GPC chart is determined. Here, in the case of the GPC chart of FIG. 3, a peak derived from a binder resin is a peak wherein the elution time is about from 12 to 18.5 minutes and peak area (S_{A}) is 11000 (mV·S).

From the results of the above measurements, the ratio of the peak area (S_{A}) derived from a binder resin shown in the GPC chart of a toner (T_{A}) to the peak area (S_{B}) (100%) derived from a binder resin shown in the GPC chart of a standard toner (T_{B}) is obtained. The ratio of the peak area (S_{A}) derived from a binder resin shown in the GPC charts of FIG. 2 and FIG. 3 is 73%.

### THF-Insoluble Component

A THF-insoluble component in a toner is a group of polymers included in a toner, which polymers have a high cross-linked degree. The THF-insoluble component can be described as a gel component. When the large amount of a THF-insoluble component is included in a toner, fixing property at a low temperature of the toner tends to deteriorate since Tg and melt viscosity thereof become high in general, although offset resistance tends to be improved. The present invention aims to maintain good balance of a THF-insoluble component in order to achieve both of excellent image characteristics and excellent fixing property.

### Developer

A toner of the present invention can be used as a toner component for many kinds of developers. It is preferable that a toner of the present invention be used as a toner for a non-magnetic mono-component developer. Of course, it is possible to use a toner of the present invention for a developer which is a two component type magnetic developer. A toner of the present invention can be added with extra additives as required, for example, when it is used as a toner for a non-magnetic mono-component developer. Examples of the external additives include inorganic particles which can act as a fluidity improving agent and an abrasive, and organic resin particles.

Examples of the inorganic particles include silicon dioxide (silica), aluminium oxide (alumina), titanium oxide, zinc oxide, tin oxide, barium titanate and strontium titanate.

Examples of the organic resin particles include methacrylate polymer particles, acrylate polymer particles, styrene-methacrylate copolymer particles, styrene-acrylate copolymer particles and a core-shell type particles wherein a core is formed by the styrene polymer and a shell is formed by the methacrylate copolymer. Among them, inorganic oxide particles are preferable, and silicon dioxide is especially preferable. As the inorganic particles, they may be inorganic particles wherein the surface thereof is treated by surface hydrophobic treatment, and a silicon dioxide wherein the surface thereof is processed by hydrophilic treatment is especially preferable.

An external additive usable in the present invention may be used singly or combination of two or more. When external additives are used in combination, the combination of inorganic particles which have different diameter from each other, the combination of an inorganic particle and an organic particle or the like is preferable. The amount of an external additive can be selected as required, and it is preferable that the external additive is used in an amount of 0.1 to 6 parts by mass based on 100 parts by mass of a toner.

As a method for adding an external additive onto a toner, a method can be cited wherein a toner and an external additive are added in a mixer such as the Henschel mixer and then they are mixed.

### EXAMPLES

### Example I-1

A solution wherein 80 parts by mass of styrene, 20 parts by mass of 2-ethylhexyl methacrylate, 5 parts by mass of carbon black (MA-100, available from Mitsubishi Chemical Corporation), 3 parts by mass of a releasant (Carnauba Wax Type 1, available from S. Kato & Co.), 5.0 parts by mass of a charge control agent (N-07, available from Orient Chemical Industries) and 1.0 part by mass of a macro monomer, in which a functional group existing at a molecular terminal end of a cross-linkable compound was substituted with a methacryloyl group, were mixed, and the solution was dispersed sufficiently with a ball mill. Subsequently, 20 parts by mass of 2,2′-azobis(2,4-dimethylvaleronitrile) as a polymerization initiator and 2.0 parts by mass of t-dodecyl mercaptan as a molecular weight controlling agent were further added to the solution to prepare a monomer composition. The monomer composition was added to 400 parts by mass of ion exchanged water, and then, 0.1 part by mass of sodium dodecylbenzene sulphonate and 5 parts by mass of tricalcium phosphate as a dispersion stabilizer were added thereto, and it was stirred for 45 minutes at a rotating speed of 5000 rpm with a TK homomixer (available from Tokushu Kika Kogyo Co., Ltd.) to obtain a suspension. While it was stirred at a rotating speed of 100 rpm, said obtained suspension was heated for 10 hours at 70° C. in an atmosphere of nitrogen gas to polymerize the monomer composition. Subsequently, an acid washing of the obtained dispersion of a colored polymer particle was conducted to remove tricalcium phosphate. Then, the dispersion was filtrated to obtain the colored polymer particles, and the collected colored polymer particles were washed and dried to obtain a toner. The volume mean particle diameter (Dv) of the toner was 7.5 μm.

100 parts by mass of the toner and 0.8 parts by mass of an external additive (SILICA RA200HS, available from Nippon Aerosil Co., Ltd.) were mixed for 10 minutes at a rotating speed of 3500 mm/second to obtain a non-magnetic mono-component developer.

### Examples I-2 to I-4 and Comparative Examples I-1 to I-3

Toners and non-magnetic mono-component developers were obtained similar to Example I-1 except that the macro monomer as a cross-linkable compound was changed to vinyl benzene and the amount of the cross-linkable compound of Example I-1 was changed to those shown in Table 1.

### Comparative Example I-4

Toners and nonmagnetic type mono-component developers were obtained similar to Example I-1 except that a cross-linkable compound was not used.

### Evaluations

Evaluations of toners and non-magnetic mono-component developers of Examples I-1 to I-4 and Comparative Examples I-1 to I-3 were conducted as follows. Results of the evaluations are shown in Table 1.

### Evaluation of Filtration Velocity

(i) 15 mg of each toner of Examples I-1 to I-4 and Comparative Examples I-1 to I-4 was measured accurately and was provided in a sealable vessel. Furthermore, 5 mL of THF was accurately measured with a transfer pipette and added to each vessel. After sealing was conducted, the sealed vessels were tamed using a ball mill for 24 hours to dissolve all of a soluble component completely to prepare sample liquids.

(ii) The filtration was carried out using a filter having an area of 4.0 cm² and a pore size of 0.45 μm (Chromatdisk 25N, available from Juji Field ink.). A pressure was provided only by the weight of each sample liquid itself for a period from the beginning of the filtration until 30 minutes had passed. Then, when 30 minutes had passed, the pressure of 0.15 kgf/cm² was applied to each sample liquid. The filtration time from when the pressure of 0.15 kgf/cm² was applied and until 1 mL of the sample liquid had passed was measured, and filtration velocity was obtained by a following formula.

Filtration velocity (mL/min)=1 (mL)/filtration time (min)

### Number Average Molecular Weight

GPC measurement of the sample liquids passed through a filter was conducted using a following apparatus and by the following conditions.

GPC apparatus: HLC-8220GPC (available from Toso Corporation), solvent: THF, Flow velocity: 1.0 ml/min, Sample column: TSK-GEL GMH_{XL}×2, Reference column: TSK-GEL GRCX_{LH}.

Due to the peak derived from a binder resin shown in the obtained GPC chart, the number average molecular weight (“Mn” in Table) was obtained. The results are shown in Table 1.

### Melt Viscosity

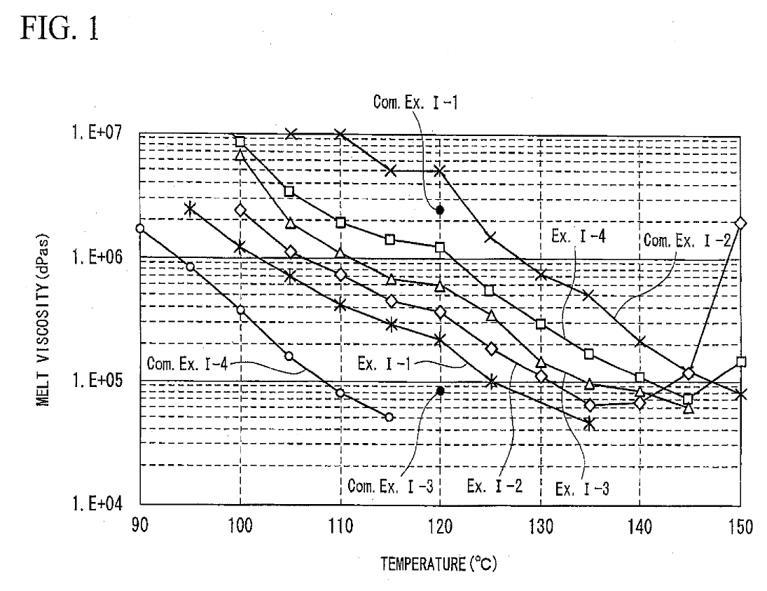

Melting viscosity of each toner was measured by the following conditions using a flow tester (CFT-500A, available from Shimadzu corporation). The obtained chart is shown as FIG. 1. Melting viscosity of a toner at 120° C. is shown in Table 1.

Temperature raising speed: 6° C./min

Preheating time: 300 seconds

Temperature at the start of measurement: 40° C.

load: 20 kgf

Die diameter: 1 mm

Die length: 1 mm

Plunger area: 1 cm²

### Evaluation of Fixing Property

A non-fixed image was printed with a printer (DP560, available from Mita Industrial Co., Ltd.) in which non-magnetic mono-component developer was provided. Said image was obtained as an image printed on a recording medium, which was an evaluation paper (COLOR COPY 90, available from NOISHIDLAR Corporation), at the toner amount of 1.5 mg/cm². Subsequently, the non-fixed image was fixed with a fixing device, which was a device altered from a commercial fixing unit (FS-1800, available from Kyocera Mita Corporation), by the following conditions to evaluate offset resistance and peeling tape property. The results are shown below.

Linear velocity adopted in the evaluation: 150 mm/sec

Temperature adopted in the evaluation: optionally selected (150 to 210° C., each evaluation was conducted from 150 to 210° C. for each 10° C. rise.)

### Offset Resistance

Evaluation was conducted such that a case where an offset image pattern was confirmed every heating roller cycle was shown as “×” (poor), and a case where no offset image pattern was confirmed was shown as “◯” (good). In Table, “Hot” means that hot offset (phenomenon wherein a melting toner of a printed image is adopted to a heat roller after fixing) is generated, and “Cold” means that cold offset (phenomenon wherein a part of an image which should be fixed is taken by a heat roller because fixed toner particles existing near the interface of toners and a recording medium cannot be melted sufficiently and therefore an image cannot be fixed sufficiently) is generated.

### Peeling Tape Property

Commercial cellophane-tape was pasted on a surface of a fixed image, and said tape was peeled off vertically. Each peeled state was evaluated using a limited sample prepared for comparison. The higher symbol means the better result of the evaluation.
◯: No-peeling
Δ: Small peeling
×: Peeling occurred

TABLE 1

| | |
|---|---|
| Cross-linkable compound | Fixing property |

| | | Amount | | Filtration velocity | Melt viscosity | | Peeling tape |
|---|---|---|---|---|---|---|---|
| | Type | (parts by mass) | Mn | (mL/min) | (dPas) | Offset resistance | property |
| Ex. I-1 | Macro monomer | 1.0 | 9000 | 0.25 | 2.1 × 10⁵ | ◯ | ◯ |
| Ex. I-2 | Divinylbenzene | 2.0 | 10000 | 0.20 | 3.8 × 10⁵ | ◯ | ◯ |
| Ex. I-3 | Divinylbenzene | 2.3 | 18000 | 0.18 | 8.0 × 10⁵ | ◯ | ◯ |
| Ex. I-4 | Divinylbenzene | 3.5 | 25000 | 0.13 | 1.1 × 10⁶ | ◯ | Δ |
| Com. Ex. | Divinylbenzene | 4.2 | 31000 | 0.09 | 2.5 × 10⁶ | X | Δ |
| I-1 | | | | | | (Cold) | |
| Com. Ex. | Divinylbenzene | 5.5 | 35000 | 0.07 | 5.8 × 10⁶ | X | X |
| I-2 | | | | | | (Cold) | |
| Com. Ex. | Divinylbenzene | 0.2 | 7000 | 0.40 | 8.1 × 10⁴ | X | ◯ |
| I-3 | | | | | | (Hot) | |
| Com. Ex. | None | 0 | 6000 | 1.03 | About 3 × 10⁴ | X | ◯ |
| I-4 | | | | | | (Hot) | |

As shown in the aforementioned results, a toner for electrophotography of the first aspect of the present invention can achieve excellent offset resistance particularly, hot offset resistance) without the deterioration of fixing property, and furthermore, fixing controllable range (fixing margin) of the toner is wide. Accordingly, the toner can be used effectively for a full color printing, which requires fixing plural toner layers on a recording medium and for a printing wherein a toner is used for printing any of various recording media other than paper.

### Example of the Second Aspect of the Present Invention

### Example II-1

A solution wherein 80 parts by mass of styrene, 20 parts by mass of 2-ethylhexyl methacrylate, 5 parts by mass of carbon black MA-100, available from Mitsubishi Chemical Corporation), 3 parts by mass of low-molecular polypropylene as a releasant (BISCOL 660, available from Sanyo Chemical Corporation), 5 parts by mass of a charge control agent (N-07, available from Orient Chemical Industries) and 1.0 part by mass of a macro monomer (number mean particle diameter: 1500), in which a functional group existing at a molecular terminal end of a cross-linkable compound was substituted with a methacryloyl group which was a cross-linkable functional group, were mixed, was dispersed sufficiently with a ball mill. Subsequently, 2.0 parts by mass of 2,2′-azobis(2,4-dimethylvaleronitrile) as a polymerization initiator and 3.0 parts by mass of t-dodecyl mercaptan as a molecular weight controlling agent were further added to the solution to prepare a monomer composition.

The monomer composition was added to 400 parts by mass of ion exchanged water, and 0.1 part by mass of sodium dodecylbenzene sulphonate and 5 parts by mass of tricalcium phosphate as a dispersion stabilizer were added to the monomer composition. It was further stirred for 45 minutes at a rotating speed of 5000 rpm with a TK homomixer (Tokushu Kika Kogyo Co., Ltd.) to obtain a suspension. Said suspension was heated for 10 hours at 70° C. in an atmosphere of nitrogen gas to polymerize the monomer composition. Then, an acid washing of the obtained dispersion of colored polymer particles was conducted to remove tricalcium phosphate. Then, the dispersion was filtrated to obtain the colored polymer particles, and the collected colored polymer particles were washed and dried to obtain a toner. The volume mean particle diameter (Dv) of the toner was 7.5 μm.

100 parts by mass of the toner and 0.8 parts by mass of an external additive (SILICA RA200HS, available from Nippon Aerosil Co., Ltd.) were mixed for 10 minutes at a rotating speed of 3500 mm/second to obtain a non-magnetic mono-component developer

### Examples II-2 and II-3

Toners and non-magnetic mono-component developers were obtained similar to Example II-1 except that the amount of the macro monomer was changed to those described in Table 2.

### Example II-4

A toner and non-magnetic mono-component developer were obtained similar to Example II-1 except that macro monomer was changed to macro monomer having a different number average molecular weight as shown in Table 2 and the amount thereof was also changed.

### Comparative Example II-1

A toner and a non-magnetic mono-component developer were obtained similar to Example II-1 except that macro monomer was changed to divinylbenzene and the amount of divinylbenzene shown in Table 2 was used.

### Comparative Example II-2

A toner and a non-magnetic mono-component developer were obtained similar to Example II-1 except that the macro monomer having the number average molecular weight of 1500 was changed to a macro monomer having the number average molecular weight of 10000, and the amount of the macro monomer was changed as shown in Table 2.

### Comparative Example II-3

Toner (standard toner (T_{B})) and a non-magnetic mono-component developer were obtained similar to Example II-1 except that macro monomer was not used.

### Evaluations

Following evaluations of toners and non-magnetic mono-component developers of Examples II-1 to I-4 and Comparative Example I-1 to i-3 were conducted. Results of the evaluations are shown in Table 2.

### GPC Measurement

(i) 15 mg of each toner of Examples II-1 to II-3 and Comparative Examples II-1 to II-2, which was measured accurately, was provided in each scalable vessel. Subsequently, 5 mL of THF, which was measured accurately with a transfer pipette, was added to each vessel. After sealing, the vessels were turned using a ball mill for 24 hours at 100 rpm to dissolve all of a soluble component completely to prepare a sample liquids A.

(ii) A filtration of the sample liquid A was carried out using a filter having an area of 4.0 cm² and a pore size of 0.45 μm (CHROMATDISK 25N, available from Juji Field ink.) at the pressure of 0.15 kgf/cm² to remove a THF-insoluble component which could not pass through the filter.

(iii) GPC measurement of the sample liquid A passed through the filter was conduced by the following condition using a following apparatus.

GPC apparatus: HLC-8220GPC (available from Toso Corporation), solvent: THF, Flow velocity: 1.0 ml/min, Sample column: TSK-GEL GMH_{XL}×2, Reference column: TSK-Gel GRCX_{LH}.

Peak area (S_{A}) which existed between a base line and a peak derived from a binder resin shown in the GPC chart was determined.

(iv) Next, the toner of Comparative Example II-3 was prepared as a standard toner (T_{B}), which was produced without using a cross-linkable component, for a comparison with a macro monomer.

(v) Peak area (S_{B}) of a standard toner (T_{B}) existing between a base line and a peak derived from a binder resin, which was derived from a binder resin shown in the GPC chart, was determined by conducting similar steps of (II-i) to (II-iii).

The ratio of the peak area (S_{A}) derived from a binder resin shown in the GPC chart of a toner (T_{A}) based on the peak area (S_{D}) (100%) derived from a binder resin shown in a GPC chart of a standard toner (T_{B}) was obtained (shown as “area ratio” in Table 2). Results are shown in Table 2.

### THF-Insoluble Component Remained on a Mesh

50 mg of a toner was added to 15 mL of THF, and it was stirred at 100 rpm for one hour at the temperature of 25° C. with a ball will to dissolve a soluble component completely. The obtained liquid was filtrated with a mesh having 650 μm openings (650 μm mesh, available from Mitsui Kanaami Seisakujyo Corporation), and whether or not a THF-insoluble component remained on the mesh was determined by visual observation.

Similarly, 50 mg of a toner was added to 15 mL of THF, and it was stirred for one hour at the temperature of 25° C. with a ball mill to dissolve a soluble component completely. The obtained liquid was filtrated with a mesh having a 150 μm openings (150 μm mesh, available from Mitsui Kanaami Seisakujyo Corporation), and whether or not a THF-insoluble component remained presented on the mesh was determined by visual observation.

It was shown as “◯” (exist) when a THF-insoluble component existed on the mesh, and it was shown as “×” (not existing) when a THF-insoluble component did not exist on the mesh.

### Pigment Included in a THF-Insoluble Component

A THF-insoluble component existing on a mesh having 650 μm openings obtained by the above evaluation was observed visually, and it was shown as “◯” (exist) when pigment existed in a THF-insoluble component and it was shown as “×” (not-exist) when pigment did not exist in a THF-insoluble component.

### Evaluation of Fixing Property

Images were printed similar to those of the evaluation of fixing property for Examples I for the first aspect, and offset resistance and peeling tape property were evaluated by the following conditions. Results are shown in Table 2.
Linear velocity adopted in the evaluation: 150 mm/sec
Evaluation Temperature: 210±5° C. (offset resistance), 150±5° C. (peeling tape property)

### Offset Resistance

Offset resistance was evaluated similar to those of Examples I of the first aspect.

### Peeling Tape Property

Peeling tape property for the second aspect was evaluated similar to those of Examples I for the first aspect. In Table 2, “Hot” means that surface condition of an image deteriorates since hot offset is generated, and therefore peeling tape property deteriorates. On the other hand, “Cold” means that toner cannot be fixed on paper since cold offset is generated, and therefore peeling tape property deteriorates.

### Evaluation of Coloring Property

Image density of the image, which was printed in the above evaluation of fixing property, was measured. Measurement of image density was conducted such that image density of a black solid image portion of the image was measured with the GretagMacbeth densitometer (RD-19 type, available from SAKATA INX Corporation).

TABLE 2

| | | | | Toner | | | | | | | |
|---|---|---|---|---|---|---|---|---|---|---|---|
| | | | | | | THF-insoluble | THF-insoluble | | | | |
| | Cross-linkable compound | | | | | component | component | Pigment | Coloring | Fixing property | |
| | | | Amount | Aria | | remained on a | remained on a | included in | property | | Peeling |
| | | | (parts by | ratio | | 650 μm type | 150 μm type | THF-insoluble | Image | Offset | tape |
| | Type | Mn | mass) | (%) | Mn* | mesh | mesh | component | density | resistance | property |
| Ex. II-1 | Macro monomer | 1500 | 1.0 | 88 | 5000 | X | ◯ | ◯ | 1.31 | ◯ | ◯ |
| Ex. II-2 | Macro monomer | 1500 | 2.5 | 80 | 7000 | X | ◯ | ◯ | 1.29 | ◯ | ◯ |
| Ex. II-3 | Macro monomer | 1500 | 3.0 | 67 | 10000 | X | ◯ | ◯ | 1.30 | ◯ | ◯ |
| Ex. II-4 | Macro monomer | 600 | 4.5 | 70 | 25000 | X | ◯ | ◯ | 1.30 | ◯ | ◯ |
| Com. | Divinylbenzene | 1500 | 4.5 | 63 | 6000 | X | ◯ | X | 1.05 | ◯ | ◯ |
| Ex. II-1 | | | | | | | | | | | |
| Com. | Macro monomer | 10000 | 6.5 | 35 | 50000 | ◯ | ◯ | X | 0.98 | X | X |
| Ex. II-2 | | | | | | | | | | (Cold) | (Cold) |
| Com. | None | — | 0 | 100 | 3000 | X | X | — | 1.24 | X | X |
| Ex. II-3 | | | | | | | | | | (Hot) | (Hot) |

*“Mn” means molecular weight obtained by GPC measurement of a sample liquid passed through a filter.

Coloring properly of the toners of Comparatives II-1 and II-2 wherein a THF-insoluble component of the toners did not include pigment therein was poor. The toner of comparative Example II-2 which included large amounts of a THF-insoluble component showed poor fixing property at a low temperature.

The toner which did not include a THF-insoluble component showed poor hot offset resistance.

The toner of the second aspect of the present invention can achieve excellent hot offset resistance, fixing property at a low temperature and color property of an image without the deterioration of fixing property, even when plural toner layers are fixed. Therefore, the toner can be used preferably for full color printing wherein plural toner layers are fixed on a recording medium.

What is claimed is:

1. A toner for electrophotography, wherein the toner is prepared by a suspension polymerization or emulsion polymerization from a monomer composition comprising a monovinyl monomer and a coloring agent;
a filtration velocity of the toner is in the range of 0.1 to 3.0 mL/min; and
the filtration velocity is obtained by an evaluation method comprising the following evaluation steps:
(i) 15 mg of a toner is added to 5 mL of THF, and a soluble component in the toner is dissolved in THF completely to prepare a sample liquid; and
(ii) the sample liquid is filtrated at the temperature of 25° C. and pressure of 0.15 kgf/cm² is applied using a filter wherein an area thereof is 4.0 cm² and a pore size thereof is 0.45 μm to measure a filtration time wherein 1 mL of the sample liquid is passed through the filter, and a filtration velocity is determined using the filtration time by a following formula,
Filtration velocity (mL/min)=1 (mL)/filtration time (min).

2. The toner for electrophotography according to claim 1, wherein a number average molecular weight of a binder resin of the toner is in the range of 8000 to 30000, and said molecular weight is obtained by conducting a GPC measurement of a filtrate of the sample liquid which is passed through the filter.

3. The toner for electrophotography according to claim 1, wherein the monomer composition further comprises a cross-linkable compound, and the amount of the cross-linkable compound is 0.5 to 5 parts by mass based on 100 parts by mass of the monovinyl monomer.

4. The toner for electrophotography according to claim 3, wherein the cross-linkable compound is a macro monomer.

5. The toner for electrophotography according to claim 1, wherein melting viscosity of the toner at 120° C. is in the range of 1×10⁵ to 1×10⁶ dPas.

6. The toner for electrophotography according to claim 4, wherein the number average molecular weight of the macro monomer is in the range of 500 to 5000, and at least one of polymerizable unsaturated carbon-carbon double bonds existing at a terminal end of a molecular chain of the macro monomer is selected from the group consisting of a vinyl group, an acryloyl group and a methacryloyl group.

7. The toner for electrophotography according to claim 4, wherein the macro monomer is a hydrophilic macro monomer, which is prepared by polymerizing methacrylate or acrylate, or polymerizing methacrylate or acrylate in combination.

8. The toner for electrophotography according to claim 1, wherein the toner is a toner for a non-magnetic mono-component developer.

9. The toner for electrophotography according to claim 1, wherein the monovinyl monomer is at least one selected from the group consisting of styrene, vinyltoluene. a-methyl styrene, (meth)acrylic acid, methyl(meth)acrylate, ethyl(meth)acrylate, propyl(meth)acrylate, butyl(meth)acrylate, 2-ethylhexyl(meth)acrylate, cyclohexyl isobornyl(meth)acrylate, dimethylaminoethyl(meth)acrylate, (meth)acrylic acid unite; ethylene, propylene and butylene.

10. The toner for electrophotography according to claim 3, wherein the cross-linkable monomer is at least one selected from the group consisting of divinylbenzene, divinyl naphthalene, ethylene glycol dimethacrylate, diethylene glycol dimethacrylate, 1,4-butanediol diacrylate, N,N-divinyl aniline, divinyl ether, pentaerythritol triallyl ether and trimethylolpropane triacrylate.

11. A toner for electrophotography, wherein the toner comprises a binder resin and a pigment;
when filtration of a liquid wherein 50 mg of a toner is added to 15 mL of THF is conducted with a mesh having 650 μm openings, none of a THF-insoluble component remains on the mesh;
when filtration of said liquid is conducted with a mesh having 150 μm openings, a THF-insoluble component of the binder resin remains on the mesh; and
a THF-insoluble component of the binder resin includes a pigment therein.

12. The toner for electrophotography according to claim 11, wherein
the toner is prepared by a suspension polymerization or emulsion polymerization from a monomer composition comprising a monovinyl monomer and a pigment; and
the ratio of a peak area (S_{A}) based on a peak area (S_{B}) (100%) obtained by a GPC measurement is 50 to 95%;
the peak area (S_{A}) is derived from a binder resin shown in a GPC chart of an object from which a THF-insoluble component, which does not pass through a filter having 0.45 μm openings, has been removed from the toner as a toner (T_{A}) by steps (II-i) and (II-ii); and
the peak area (S_{B}) is derived from a binder resin shown in a GPC chart of a standard toner (T_{B}), and
the GPC measurement includes following steps:
(II-i) 15 mg of the toner (T_{A}) is added to 5 mL of THF, a soluble component of the toner (T_{A}) is dissolved in THF completely to prepare a sample liquid A;
(II-ii) using a filter having an area of 4.0 cm² and a pore size of 0.45 μm, filtration of the sample liquid A is conducted at a pressure of 0.15 kgf/cm² to remove a THF-insoluble component which does not pass through the filter;
(II-iii) measurement of gel permeation chromatography of a filtrated of the sample A passed through the filter is conducted to obtain a GPC chart, and the peak area (S_{A}) existing between a base line and a peak line originated from a binder resin is determined;
(II-iv) the standard toner (T_{B}) is prepared by polymerizing a monomer composition (M_{B}), which has the same composition as the monomer composition (M_{A}) except that a cross-linkable compound is not used, under the same conditions as those of the monomer composition (M_{A}); and
(II-v) using the standard toner (T_{B}), aforementioned (II-i) to (II-iii) steps are conducted in that order to obtain the peak area (S_{B}) derived from a binder resin of the standard toner (T_{B}) from a GPC chart of the standard toner (T_{B}).

13. The toner for electrophotography according to claim 12, wherein a number average molecular weight of the binder resin, which is obtained by the GPC measurement of the sample liquid A passed through the filter having 0.45 μm openings, is in the range of 8000 to 30000.

14. The toner for electrophotography according to claim 12, wherein the monomer composition (M_{A}) comprises a macro monomer, and the amount of the macro monomer is in the range of 0.5 to 5 parts by mass, based on 100 parts by mass of the monovinyl monomer.

15. The toner for electrophotography according to claim 12, wherein the monomer composition (M_{A}) comprises a macro monomer, and the macro monomer has two or more polymerizable unsaturated carbon-carbon double bonds at a terminal end of a molecular chain thereof, and the number average molecular weight of the macro monomer is in the range of 500 to 5000.

16. The toner for electrophotography according to claim 12, wherein the monomer composition (M_{A}) comprises cross-linkable compounds, and the amount of a macro monomer as a cross-linkable compound within the cross-linkable compounds is 70 parts by mass or more.

17. The toner for electrophotography according to claim 12, wherein the cross-linkable compounds consists of a macro monomer.

18. The toner for electophotography according to claim 12, wherein a monomer composition (M_{A}) comprises a macro monomer, and the amount of the macro monomer is in the range of 0.5 to 5 parts by mass based on 100 parts by mass of the monovinyl monomer.

19. The toner for electrophotography according to claim 11, wherein the toner is prepared by a suspension polymerization or emulsion polymerization using a monomer composition which comprises a monovinyl monomer and a pigment, and is a toner for a non-magnetic mono-component developer.

20. The toner for electrophotography according to claim 12, wherein the monomer composition (M_{A}) comprises a cross-linkable monomer, and the cross-linkable monomer is at least one selected from the group consisting of divinylbenzene, divinyl naphthalene, ethylene glycol dimethacrylate, diethylene glycol dimethacrylate, 1,4-butanediol diacrylate, N,N-divinyl aniline, divinyl ether, pentaerythritol triallyl ether and trimethylolpropane triacrylate.
